(19) United States
(12) Patent Application Publication
(10) Pub. No.: US 2026/0099591 A1
(43) Pub. Date: Apr. 9, 2026

(54) SOFTWARE REMEDIATION USING PARALLEL CODE FRAGMENTS

(71) Applicant: Unisys Corporation, Blue Bell, PA (US)

(72) Inventors: Matthew MILLER, Irvine, CA (US); David STRONG, Irvine, CA (US); Anthony MATYOK, West Chester, PA (US)

(21) Appl. No.: 18/905,747

(22) Filed: Oct. 3, 2024

(51) Int. Cl. G06F 21/55

(52) U.S. Cl. CPC G06F 21/554; G06F 2221/033

(57) ABSTRACT

In various examples, an executable object including parallel code fragments that allow compromised code within the executable object to be remediated. For example, when a selection mask is enabled, instructions encoded in the executable object are translated for execution by the one or more processors. Continuing this example, the executable object includes the parallel code fragment that allow vulnerable operations to be bypassed. Furthermore, once enabled and the compromised code is bypassed, a remediation is applied to the executable code.

### BACKGROUND

Computing environments are increasing in complexity and capabilities. As a result, the number of exploits and attacks are increasing in number and sophistication. For example, a server computer system can be subject to any number of attacks exposing or otherwise exploiting vulnerabilities in the hardware, software, and/or combination thereof of the server computer system. In some instances, new computing hardware and/or software creates a risk of new and unknown flaws (e.g., a zero-day attack). In addition, attackers are becoming more sophisticated and better at detecting flaws in computer hardware and/or software. Accordingly, it can be difficult to protect and mitigate from otherwise unknown potential future attacks to any number of computer hardware and/or software components of complex computing devices such as server computer systems.

### SUMMARY

Embodiments described herein include methods and systems for remediating various types of cyber security events using parallel code fragments in executable code. In one example, parallel code fragments included in executable code enable modification of a code path and/or code stream to enable mitigation, bypass, and/or remediation of compromised executable code. In an embodiment, in response to detecting anomalous activity (e.g., an attack), a parallel code fragment including a pointer and/or reference to another code path is selected during code translation in a computing environment, thereby causing the computing environment to bypass compromised executable code. Furthermore, in such embodiments, the compromised executable code can be remediated (e.g., patched), and the parallel code fragment can be deselected.

Advantageously, in various embodiments, the systems and methods described allow or otherwise enable users (e.g., via an intrusion detection system) to remediate compromised executable code without downtime to the computing environment. In particular, the parallel code fragments can be enabled dynamically without the need to recompile or otherwise cause any down time for the computing environment or component thereof. For example, a user can enable parallel code fragments in response to an attack within a computing environment through a user interface without the need to recompile the executable code currently being executed by processors of the computing environment.

### BRIEF DESCRIPTION OF THE DRAWINGS

The present disclosure is described in detail below with reference to the attached drawing figures, wherein:

FIG. 1 depicts an environment in which one or more embodiments of the present disclosure can be practiced.

FIG. 2 depicts an environment in which an executable object including parallel code fragments is executed, in accordance with at least one embodiment.

FIG. 3 depicts an environment in which a software is remediated using parallel code fragments, in accordance with at least one embodiment.

FIG. 4 depicts an environment in which an intrusion detection system remediates an application executed by a hosted environment, in accordance with at least one embodiment.

FIG. 5 depicts an environment in which an executable object including parallel code fragments is executed, in accordance with at least one embodiment.

FIG. 6 depicts an example process flow for remediating software using parallel code fragments, in accordance with at least one embodiment.

FIG. 7 depicts an example process flow for remediating software using parallel code fragments, in accordance with at least one embodiment.

FIG. 8 depicts an example process flow for generating an executable object including parallel code fragments, in accordance with at least one embodiment.

FIG. 9 is a block diagram of an exemplary computing environment suitable for use in implementations of the present disclosure.

### DETAILED DESCRIPTION

Embodiments described herein generally relate to enabling software remediation using parallel code fragments in executable code. In accordance with some aspects, the systems and methods described generate an executable object (e.g., an executable file, processor executable, or other data that can be directly executed by a processor) that includes parallel code fragments including a link or other mechanism for mitigating and/or remediating compromised executable code. In various embodiments, the executable object includes parallel code fragments that can be dynamically executed and/or enabled in a particular computing environment. For example, selection of a particular parallel code fragment associated with remediation causes the hosted computing environment to modify execution to bypass compromised executable code. In various embodiments, by enabling the parallel code fragment, the code path of the executable object is modified by at least linking to a modified code path that does not include the compromised executable code.

In one example, a computing environment, such as a server computer system, includes an intrusion detection system that monitors operation of the server computer systems and detects when normal operation of the server computer system is compromised. Continuing this example, the intrusion detection system, in response to anomalous activity such as threats, policy violations, unauthorized access, or other actions that compromise the computing environment, enables one or more parallel code fragments in an executable object that is executed by the server computer system. The executable object, in an embodiment, is generated as a result of a compilation process that translates source code written in a programming language to machine code that is executable directly by the processor or other computer hardware. In addition, a portion of the instructions included in the executable object, in one example, are compromised, and, as a result of being executed by the computing environment or component thereof, cause the computing environment or component thereof to generate or otherwise perform operations resulting in the anomalous activity detected by the intrusion detection system.

In a specific example, an update to the executable object creates a vulnerability in the computing environment that enables unauthorized access. Furthermore, in various embodiments, the executable object includes parallel code fragments that include a link or pointer (e.g., a thunk, trampoline, etc.) to a different code path to enable the intrusion detection system to bypass the portion of the executable object that creates the vulnerability. For example, the executable object includes parallel code fragments at various locations (e.g., between functions and/or operations of an application) that include pointers to memory location or includes some operation that is dormant until activated. These parallel code fragments, in various embodiments, as a result of being executed, cause the computing environment to alter the program flow to execute an alternate code path. In an embodiment, the pointer causes the computing environment to execute a memory load instruction that, as a result of being activated, causes the computing environment to execute another code path. Continuing the example above, when anomalous activity is detected by the intrusion detection system, a parallel code fragment is enabled and the pointer and/or memory location is dynamically modified to point to executable instructions such as a library or executable object. In various embodiments, enabling the parallel code fragment causes the computing environment to bypass the compromised instructions. Returning to the example above, the pointer included in the parallel code fragment modifies the code stream to execute instructions from a previous version of the executable object prior to the update that created the vulnerability that enabled the unauthorized access.

Furthermore, in some embodiments, while the executable code is being bypassed as a result of the parallel code fragment being enabled, the executable object can be remediated. In one example, a patch and/or hotfix is developed and applied to the executable object, and normal operation is resumed (e.g., the parallel code fragment is disabled). In this manner, the computing environment continues operation despite the vulnerability and/or attack, and the compromised instructions and/or vulnerability is remediated without any downtime to the computing environment.

Other solutions do not allow for vulnerabilities to be remediated without downtime to the computing environment. In one example, once an executable object (e.g., an application or portion thereof) is compromised, system downtime is required to load a second executable object that does not include the vulnerability (e.g., a previous version of the application or an alternate application), and then system downtime is required a second time to patch or hotfix the executable object. Furthermore, other systems do not allow for the selective activation of parallel code fragments. For example, these systems require the computing environment to recompile the source code or otherwise retranslate the executable object. As described above, in such examples, this causes downtime and may be undesirable in certain situations.

Aspects of the technology described herein provide a number of improvements over existing technologies. For instance, significant security is provided to the software developers to deliver an executable code package to users that can be quickly mitigated using parallel code fragments and remediated without significant downtime to the application, end-user, and/or operating system of the computing environment. In one example, a plurality of parallel code fragments are included in an executable object at strategic locations allowing for vulnerabilities in the executable code to be bypassed or otherwise mitigated without the need to recompile the executable object. In addition, the executable object can be remediated while the computing environment remains operational, reducing the impact to users. For example, this is particularly advantageous in circumstances where system uptime is critical. Furthermore, in various embodiments, the inclusion of parallel code fragments avoids both performance penalties caused by runtime checks and indirect invocations. For example, parallel code fragments do not consume computing resources until selected, eliminating overhead and performance degradations caused by conventional systems that require checks, tests, or other operations to determine if a flag or other indication of a mitigation is active.

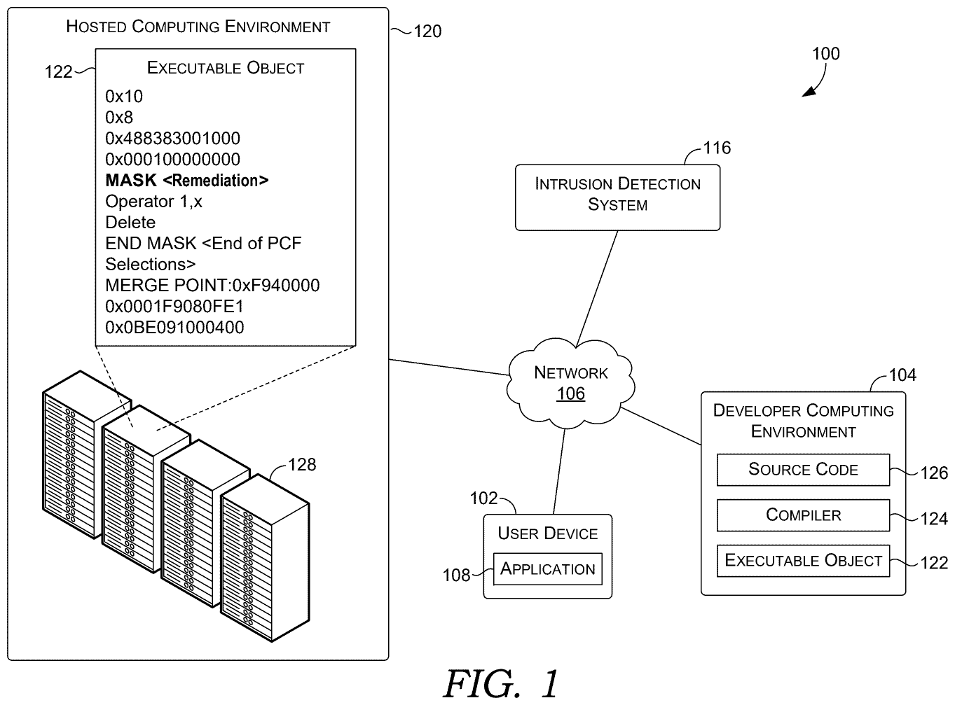

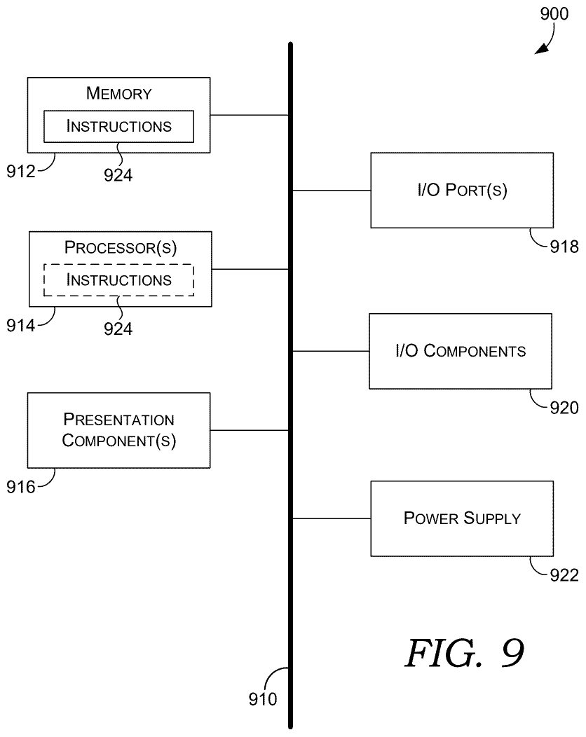

Turning to FIG. 1, FIG. 1 is a diagram of an operating environment 100 in which one or more embodiments of the present disclosure can be practiced. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether for the sake of clarity. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, some functions can be carried out by a processor executing instructions stored in memory, as further described with reference to FIG. 9.

It should be understood that operating environment 100 shown in FIG. 1 is an example of one suitable operating environment. Among other components not shown, operating environment 100 includes a user device 102, developer computing environment 104, a hosted computing environment 120, an intrusion detection system 116, and a network 106. Each of the components shown in FIG. 1 can be implemented via any type of computing device, such as one or more computing devices 900 described in connection with FIG. 9, for example. These components can communicate with each other via network 106, which can be wired, wireless, or both. Network 106 can include multiple networks, or a network of networks, but is shown in simple form so as not to obscure aspects of the present disclosure. By way of example, network 106 can include one or more wide area networks (WANs), one or more local area networks (LANs), one or more public networks such as the Internet, and/or one or more private networks. Where network 106 includes a wireless telecommunications network, components such as a base station, a communications tower, or even access points (as well as other components) can provide wireless connectivity. Networking environments are commonplace in offices, enterprise-wide computer networks, intranets, and the Internet. Accordingly, network 106 is not described in significant detail.

It should be understood that any number of devices, servers, and other components can be employed within operating environment 100 within the scope of the present disclosure. Each can comprise a single device or multiple devices cooperating in a distributed environment. For example, the developer computing environment 104, the intrusion detection system 116, and the hosted computing environment 120 includes multiple server computer systems 128 cooperating in a distributed environment to perform the operations described in the present disclosure.

User device 102 can be any type of computing device capable of being operated by an entity (e.g., individual or organization) and obtains data from developer computing environment 104 and/or a data store that can be facilitated by the hosted computing environment 120 (e.g., a server operating as a frontend for a server computer system 128). The user device 102, in various embodiments, has access to or otherwise obtains an executable object 122 from the developer computing environment. For example, the application 108 includes the executable object 122 that is compiled using the compiler 124 based on the source code 126. Continuing this example, the application 108 is executed by processors (e.g., the server computer systems 128) included in the hosted computing environment 120. In an embodiment, an entity via the user device 102 causes the server computer systems 128 of the hosted computing environment 120 to execute the application 108 based on the executable object 122.

In some implementations, user device 102 is the type of computing device described in connection with FIG. 9. By way of example and not limitation, the user device 102 can be embodied as a personal computer (PC), a laptop computer, a mobile device, a smartphone, a tablet computer, a smart watch, a wearable computer, a personal digital assistant (PDA), a global positioning system (GPS) or device, a video player, a handheld communications device, a gaming device or system, an entertainment system, a vehicle computer system, an embedded system controller, a remote control, an appliance, a consumer electronic device, a workstation, any combination of these delineated devices, or any other suitable device.

The user device 102 can include one or more processors and one or more computer-readable media. The computer-readable media can also include computer-readable instructions executable by the one or more processors. In an embodiment, the instructions are embodied by one or more applications, such as application 108 shown in FIG. 1. Application 108 is referred to as a single application for simplicity, but its functionality can be embodied by one or more applications in practice.

In various embodiments, the application 108 includes any application capable of facilitating the exchange of information between the user device 102 and the hosted computing environment 120. For example, the application 108 includes a terminal or other application for communicating with server computer systems 128 within the hosted computing environment 120. In other examples, the application 108 allows the user device 102 to communicate and/or execute the executable object 122 using computing resources of the hosted computing environment 120.

In some implementations, the application 108 comprises a web application, which can run in a web browser, and can be hosted at least partially on the server-side of the operating environment 100. In addition, or instead, the application 108 can comprise a dedicated application, such as an application being supported by the user device 102 and the hosted computing environment 120. In some cases, the application 108 is integrated into the operating system (e.g., as a service). It is therefore contemplated herein that “application”be interpreted broadly.

For cloud-based implementations, for example, the application 108 is utilized to interface with the functionality implemented by the hosted computing environment 120. In some embodiments, the components, or portions thereof, of the developer computing environment 104 and/or intrusion detection system 116 are implemented within the hosted computing environment 120 or other systems or devices. For example, the compiler 124 is executed within the hosted computing environment 120. In addition, it should be appreciated that the hosted computing environment 120, the user device 102, and the developer computing environment 104, in some embodiments, are provided via multiple devices arranged in a distributed environment that collectively provide the functionality described herein. Additionally, other components not shown can also be included within the distributed environment.

In various embodiments, the intrusion detection system 116 includes a security tool, application, or other component of the environment 100 that monitors network traffic, log data, and/or the server computer systems 128 for threats, suspicious activity, policy violations, unauthorized access, potential threats, and/or abnormal activities. In one example, the intrusion detection system 116 analyzes various data streams (e.g., network traffic over the network 106) and alerts administrators to take action (e.g., transmits a notification to the application and/or the user device 102). In one example, the intrusion detection system 116 performs anomaly detection by at least using a monitoring feature of data observability tools, which can include machine learning to identify unexpected changes in a dataset (e.g., a data stream obtained from the hosted computing environment 120 and/or server computer systems 128). Continuing this example, the intrusion detection system 116 determines data patterns to expect from the application 108, the network 106, databases, data stores, network appliances, the server computer systems 128, and/or other components of the hosted computing environment 120 and establishes a baseline for operation of the hosted computing environment 120 (e.g., “normal” operation). In various embodiments, the intrusion detection system 116 then scans and/or monitors data inputs and outputs to determine if the data patterns align with the baseline.

In various embodiments, the intrusion detection system 116 includes various systems deployed at various locations within the hosted computing environment 120 and/or outside the hosted computing environment 120. In one example, the intrusion detection system 116 includes a network intrusion detection system deployed at various network locations within the network 106 to monitor incoming and outgoing traffic to the hosted computing environment 120 or component thereof such as the server computer systems 128 to detect malicious and/or suspicious traffic coming to and going from devices connected to the network 106. In another example, the intrusion detection system 116 includes a host intrusion detection system that is executed by the server computer system 128 and/or other computing devices within the hosted computing environment 120. In various embodiments, the intrusion detection system 116 includes a hybrid intrusion detection system that include various features and/or computing devices of different types of intrusion detection systems such as protocol-based intrusion detection system, application protocol-based intrusion detection system, and the network intrusion detection system and host intrusion detection system described above.

In various embodiments, the intrusion detection system 116 maintains security and protects the host computing environment from various threats such as cyber attacks by at least detecting unauthorized access, potential threats, and abnormal activities by analyzing data streams (e.g., network traffic, logging data, etc.) and alerting other computing devices and/or administrators. In one example, an operating system executed by the server computer systems 128 obtains a notification from the intrusion detection system 116 indicating that normal operation has been compromised (e.g., a particular threat has been detected). Continuing this example, the operating system then mitigates the particular threat. In an embodiment, the operating system and/or component thereof (e.g., a command line utility) causes executable code such as a library, executable object or other instructions to be loaded into memory of the server computer systems 128 and links the executable code to the parallel code fragment. In another example, a system engineer, security engineer, administrator, or other user obtains the notification from the intrusion detection system 116 and initiates mitigation and/or remediation. In an embodiment, the user, in response to the notification from the intrusion detection system 116, causes the executable code to be loaded into memory and links the executable code to the parallel code fragment. For example, the executable code includes the mitigation to the particular threat.

As illustrated in FIG. 1, computing resources within the hosted computing environment 120, such as server computer systems 128 including processors and memory, are used to execute executable instructions encoded in an executable object 122. In addition, in various embodiments, the executable object 122 includes parallel code fragments that link to an area of memory (e.g., a thunk or trampoline). In one example, the “thunk” in a code path of the executable object 122 that includes a small piece of executable code that is called as a function, performs a small operation, and then jumps to another memory location (e.g., another function) instead of returning to the code path. In various embodiments, the thunk included in the parallel code fragment points to executable code (e.g., a function, library, instructions, etc.) that is executed by the server computer systems 128 and returns to the code path (e.g., the merge point within the executable object 122) when execution is finished.

In this manner, in an embodiment, a portion of the instructions within the executable object 122 are bypassed using the thunk in the parallel code fragment. In addition, other mechanisms for bypassing instructions of the executable object 122 and instructions illustrated in FIG. 1 can be used in accordance with various embodiments. In one example, the parallel code fragment includes a trampoline (e.g., jump instructions) or a similar operation that, as a result of being executed, causes the computer systems to execute a different code path. In various embodiments, trampolines included in the parallel code fragments are memory locations holding addresses pointing to executable code (e.g., executable code to bypass compromised instructions, operations, and/or functions of the executable object 122). In an example, when the parallel code fragment including the trampoline is enabled, execution of the trampoline instruction in the executable object 122 causes the server computer systems 128 to execute a different code path at the memory location, then, once completed, return execution to executable object 122 (e.g., return to the parallel code fragment and/or merge point). In various embodiments, the thunks, trampolines, or other operations included in the parallel code fragment are used to manage transitions between different parts of a program or different programs. As described above, these operations included in the parallel code fragment enable a transition from compromised instructions to a different set of instructions in order to bypass the vulnerability and maintain operation of the executable object 122 (e.g., the application 108).

Furthermore, in various embodiments, the parallel code fragments are dynamically selected for execution without needing to recompile the source code 126 or other executable instructions encoded in the executable object 122. In one example, the parallel code fragments are enabled via selection through the application 108. In various embodiments, a selection mask associated with the parallel code fragments is provided to firmware, an operating system, or another application managing execution of the executable object 122 within the hosted computing environment 120, which then can enable the parallel code fragments during execution by at least identifying and/or detecting the selection mask within the executable object 122. In one example, this allows for the use of a single version of the source code and/or executable object and reduces packaging overhead of developers by enabling developers to compile a single executable object 122 with a plurality of parallel code fragments that can be dynamically enabled to bypass or otherwise mitigate various portions of the executable object 122.

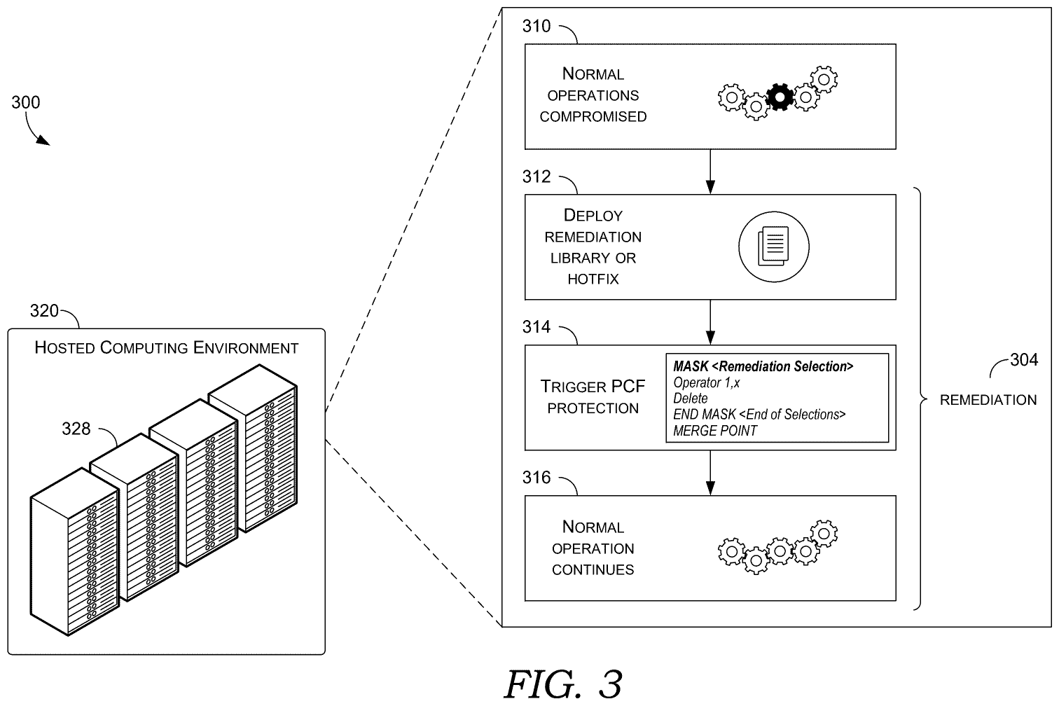

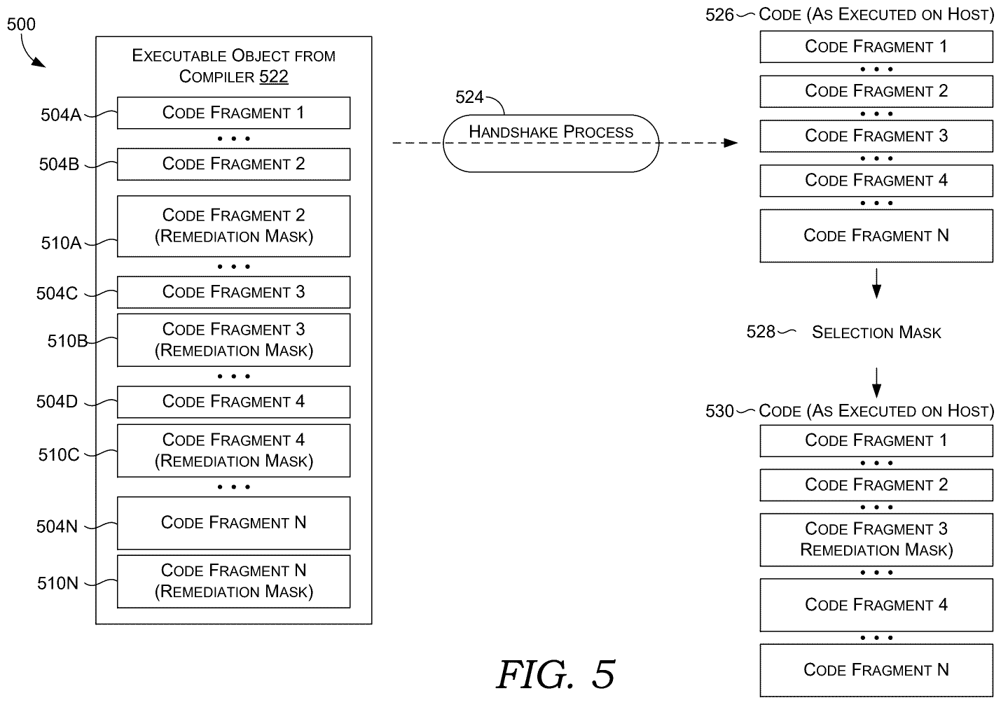

In various embodiments, a developer generates source code 126 that is compiled by a compiler 124 within a developer computing environment 104 to generate the executable object 122. In one example, the developer includes, in the source code 126, instructions in the parallel code fragments that enable mitigation and/or remediation of the executable object 122, as described in detail below in connection with FIGS. 3 and 5. In various embodiments, the compiler generates the selection mask included in the executable object 122 that, once enabled, allows the hosted computing environment 120 to execute the parallel code fragment. In addition, in one example, the selection mask includes metadata or other information that indicates to the hosted computing environment 120 the function and/or operation of the executable object 122 that is being bypassed and other information to enable users to remediate the vulnerability detected by the intrusion detection system 116.

In various embodiments, the hosted computing environment 120 includes an operating system that generates a process to manage or otherwise handle execution of the executable object 122. In such embodiments, the process is identified by a process identification number (e.g., process ID) or other information to enable the selection mask, in response to a user (e.g., through the application 108) or the intrusion detection system 116 enabling parallel code fragments, to be provided to the process executing the executable object 122. In various embodiments, the hosted computing environment 120 obtains the selection mask and determines (e.g., based at least in part on metadata included in the selection mask) the parallel code fragment to enable.

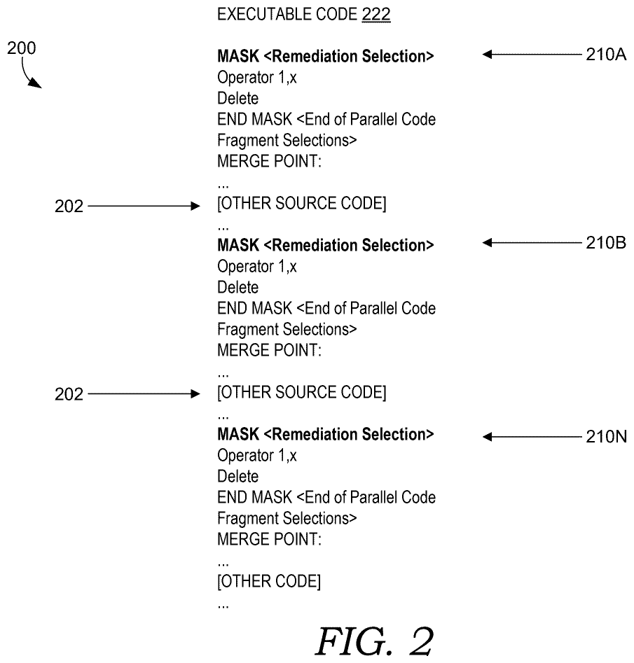

In various embodiments, once the selection mask is obtained, the hosted computing environment 120 or component of the hosted computing environment 120 (e.g., firmware, operating system, utility, etc.) retranslates the executable object during execution to activate the parallel code fragments. During execution of the executable object 122 with the selection mask enabled, for example, the hosted computing environment 120 or component of the hosted computing environment 120 processes the machine code in the executable object 122, executes the operations encoded in the parallel code fragment, and bypasses a portion of the executable object 122 by at least executing a different code path (e.g., by linking to a different location in memory storing the instructions associated with the different code path). Continuing this example, execution is then synchronized at a merge point within the executable object 122, as described below in connection with FIG. 2. In various embodiments, the different code path can be executed asynchronously.

FIG. 2 illustrates an environment 200 in which an executable object 222 including parallel code fragments with remediation selection is encapsulated, informed, and executed by a computing environment in accordance with an embodiment. In one example, the executable object 222 includes source code compiled into an executable object such as the executable object 122 described above in FIG. 1. In various embodiments, if parallel code fragments are not enabled (e.g., the intrusion detection system as described above has not selected or otherwise enabled the particular parallel code fragments illustrated in FIG. 2), the selection masks 210A, 210B, and 210N cause the computer system executing the executable object 222 to ignore the parallel code fragments. In other embodiments, if the parallel code fragments are enabled, the selection masks 210A, 210B, and 210N cause execution of source code within the parallel code fragment.

In various embodiments, the selection masks 210A, 210B, and 210N are located between other source code 202 that, as a result of being executed, cause the computing system to perform various operations. In some embodiments, the selection masks 210A, 210B, and 210N are placed at specific locations within the executable object 222. For example, the selection masks 210A, 210B, and 210N are placed between functions and/or operations of an application such as logging, networking, storage, and/or other operations that an application performs. As described above, in an embodiment, the selection masks 210A, 210B, and 210N include metadata containing information to execute the parallel code fragment such as information indicating a location within the executable object 222. In various embodiments, the parallel code fragments include a pointer to a memory location to allow the other source code 202 to be bypassed. In one example, the intrusion detection system detects that a portion of the other source code 202 is compromised (e.g., vulnerable to a potential attack or currently subject to an attack) and enables the corresponding selection masks 210A, 210B, and 210N to bypass the portion of the other source code 202 that is compromised.

In various embodiments, a pointer (e.g., thunk or trampoline) within the selection masks 210A, 210B, and 210N is updated to cause the computing environment executing the executable object 222 to execute a separate code path. In one particular example, the other source code 202 that is compromised executes a logging function of the application encoded in the executable object 222. Continuing this example, as a result of the intrusion detection systems and/or a user determining that the logging function is compromised, a substitute library or other executable code that performs the logging functions is compiled, and the pointer included in the corresponding selection mask is updated. As a result, in various embodiments, the computing environment bypasses the compromised logging function and “jumps” or otherwise continues execution of an alternative code path that includes the substitute library in order to perform the logging function. In some embodiments, the substitute library is compiled and the instructions are stored in the memory location pointed to by the corresponding selection mask.

In various embodiments, the merge point includes common code for the parallel code fragments. For example, the merge point includes instructions and/or operations to perform based on the result obtained from the alternate code path. In other examples, the merge point indicates a location within the executable object 222 to resume execution. For example, the computing device executing the executable object 222 can process the parallel code fragment and resume execution of the executable object 222 at the merge point. In various embodiments, the parallel code fragments are executed asynchronously.

FIG. 3 illustrates an environment 300 in which a remediation 304 is performed on an application executed by a server computer system 328 within a hosted computing environment 320. In one example, the application includes an executable object (e.g., source code compiled into the executable object such as the executable object 122 described above in FIG. 1) that, as a result of being executed by a processor of the server computer system 328, causes the server computer system 328 to perform various operations. In various embodiments, normal operations of the hosted computing environment 320 or component thereof (e.g., the application or server computer system 328) becomes compromised 310. For example, potential malicious actors can detect or otherwise determine a vulnerability in a portion of the application. In various embodiments, various malicious and non-malicious actions (e.g., by malicious actors or other users) cause the normal operations to be compromised 310.

In various embodiments, remediation 304 includes deploying remediation library or hotfix 312, triggering parallel code fragment protection 314, and then enabling normal operation to continue 316. As described above, in some embodiments, remediation is triggered by an intrusion detection system. In other embodiments, a user (e.g., security engineer, system administrator, etc.) triggers the remediation process. In one example, the intrusion detection system determines that normal operations are compromised and triggers parallel code fragment protection 314, while the user deploys the remediation library or hotfix 312. In general, the operations (e.g., the remediation 304 operations) shown in FIG. 3 can be performed by the intrusion detection system, the user, or a combination thereof.

In an embodiment, deploying the remediation library or hotfix 312 includes compiling a library or other executable object that replaces or otherwise bypasses the compromised operations. In one example, a particular function is compromised and allows users to exceed their access privileges; the remediation library is then deployed and used to perform the particular function and is known not to include the same vulnerability. Continuing this example, the remediation library includes a previous version of the application used to perform the particular function. In some embodiments, deploying the remediation library or hotfix 312 includes a hotfix or patch that updates and/or replaces the executable instructions within the executable object that enables or otherwise allows normal operations to be compromised 310. Returning to the example above, a software developer releases a hotfix that modifies the particular function to prevent users from exceeding access privileges.

In various embodiments, a selection mask associated with the parallel code fragments is provided to firmware, an operating system, or another application managing execution of the executable object within the hosted computing environment 320, which then triggers parallel code fragments protection 314 during execution by at least identifying and/or detecting the selection mask within the executable object. During execution of the executable object with the selection mask enabled, for example, the hosted computing environment 320 or component of the hosted computing environment 320 processes the machine code in the executable object, executes the operations encoded in the parallel code fragment, and bypasses a portion of the executable object by at least executing a different code path (e.g., by linking to a different location in memory storing the instructions associated with the different code path). Continuing this example, execution continues to the remediation library to bypass the compromised operation. In an embodiment, execution is then synchronized at a merge point within the executable object, as described above in connection with FIG. 2. In various embodiments, the different operations of the remediation 304 can be executed asynchronously. For example, the parallel code fragment protection can be triggered and execution can be bypassed to a remediation library while a software developer develops a hotfix, patch, or other executable code that causes the hosted computing environment 320 to continue normal operations 316.

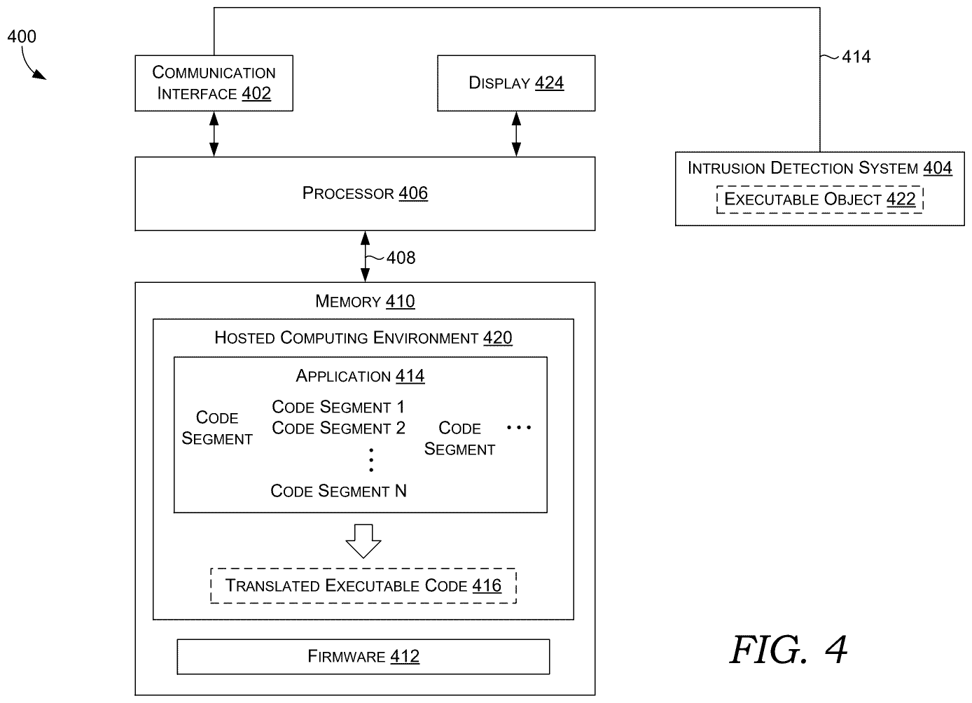

FIG. 4 illustrates an environment 400 in which a hosted computing environment executes a set of parallel code fragments including parallel code fragments for remediation in accordance with at least one embodiment. As illustrated in FIG. 4, the environment 400 includes processor 406 communicatively connected to a memory 410 via a data bus 408. The processor 406, for example, includes a variety of types of programmable circuits capable of executing computer-readable instructions to perform various tasks, such as mathematical and communication tasks, such as those described below in connection with FIG. 9. Furthermore, in some embodiments, the processor 406 includes a virtual processor.

The memory 410 can include any of a variety of memory devices, such as using various types of computer-readable or computer storage media, as also discussed below in connection with FIG. 9. In an embodiment, the memory 410 stores instructions that, as a result of being executed by the processor 406, provide a hosted computing environment 420 and firmware 412, discussed in further detail below. In various embodiments, the environment 400 includes a communication interface 402 that receives and transmits data. For example, the communication interface 402 provides access to a sharable resource such as a resource hosted by the hosted computing environment 420. Additionally, in various embodiments, a display 424 can be used for viewing a local version of a user interface (e.g., to view executing tasks on the environment 400 and/or within the hosted computing environment 420, to enable parallel code fragments, or to otherwise interact with the environment 400 and/or within the hosted computing environment 420).

In various embodiments, an intrusion detection system 404 monitors operation of the hosted computing environment 420 and/or execution of an application 414 through the communication interface 402. For example, the intrusion detection system 404 monitors log data, network data, or other data generated by the hosted computing environment 420 and/or execution of the application 414 to determine if normal operation has been compromised. For example, as described above, the intrusion detection system 404 monitors operation, determines a baseline, and detects deviation from the baseline operation to determine that normal operation has been compromised. In an embodiment, various types of intrusion detection systems are used in connection with the environment 400. Furthermore, in some embodiments, the intrusion detection system 404 provides an executable object 422 to the hosted computing environment 420 through the communication interface 402. For example, the executable object 422 is provided over a network to the hosted computing environment 420.

In various embodiments, the executable object 422 includes a library, patch, hotfix, or other executable instructions as described above that are used to mitigate and/or remediate compromised operation of the hosted computing environment 420. In one example, the executable object 422 includes a library or other executable code that, as a result of being linked to a parallel code fragment as described above, bypasses the compromised operation. In another example, the executable object 422 includes an update to executable code of the application 414 that remediates the compromised operation.

In an embodiment, the application 414 and/or the executable object 422 are executable from memory 410 by the processor 406 based on execution of firmware 412. In one example, the firmware 412 translates instructions stored in the hosted computing environment 420 for execution. In various embodiments, the hosted computing environment 420 includes or otherwise executes the application 414. For example, the application 414 is written in any programming language, or compiled in an instruction architecture, which is compatible with execution within the hosted computing environment 420. The application 414, in an embodiment, is provided to the environment 400 as executable code including a plurality of parallel code fragments.

In various embodiments, the application 414 (e.g., an executable object that is translated and executed by a processor) includes code segments that are translated into executable code 416, which is performed via cooperation with the hosted computing environment 420 and the firmware 412. For example, the hosted computing environment 420 and firmware 412 translate the application 414 into the executable code 416 using a compilation process or interpretation (e.g., translation and execution concurrently on an instruction-by-instruction basis).

Although the environment 400 illustrates a particular configuration of computing resources, it is recognized that the present disclosure is not so limited. In particular, access to sharable resources may be provided from any of a variety of types of computing environments, rather than solely from a hosted computing environment 420. The methods described below may provide secure access to such sharable resources in other types of environments.

In various embodiments, the application 414 includes a plurality of code segments (e.g., code segments 1-N) and a plurality of code paths and/or code streams. For example, the code segments encode instructions that, as a result of being executed, cause various functions and/or operations to be performed. Furthermore, in an example, the code segments include parallel code fragments that, as a result of being enabled, cause the hosted computing environment to execute a different code path and/or code stream (e.g., to bypass a compromised code path and/or code stream). In an embodiment, the processor 406 executes the application 414 by at least obtaining translated executable code 416 from the firmware 412 or another component of the hosted computing environment 420. In one example, the firmware 412 processing the application 414 (e.g., the executable object 422 that encodes the instructions associated with the application 414 or a portion thereof) obtains a code segment (e.g., a parallel code fragment) including a pointer and/or link (e.g., thunk or trampoline) that causes execution of a separate code path, thereby bypassing a compromised operation of the application 414 (e.g., detected by the intrusion detection system 404).

FIG. 5 illustrates an environment 500 in which a collection of executable code that includes parallel code fragments in a hosted computing environment, in accordance with an embodiment. For example, the environment 500 includes executable code within an executable object 522 obtained from a compiler that includes a plurality of different code fragments (shown as Code Fragments 504A-504N), and at least a portion of the different code fragments include parallel code fragments (shown as Code Fragments 510A-510N) that are used to mitigate and/or remediate compromised operations (e.g., one of Code Fragments 504A-504N) of the hosted computing environment. In the example shown, there is a set of parallel code fragments “Code Fragments” 510A-510N that allow compromised executable code to be bypassed, the parallel code fragments are selectively enabled or disabled (e.g., by a user or intrusion detection system to bypass a compromised operation).

In various embodiments, the executable object 522 includes a second set of parallel code fragments, “Code Fragment 3” 504C and “Code Fragment 3 (Remediation Mask)” 510B; however, the “Code Fragment 3 (Remediation Mask)” 510B includes executable instructions corresponding to remediation of “Code Fragment 3” 504C (e.g., an operation that causes the system executing the executable object 522 to execute a different code path that does not include “Code Fragment 3” 504C). In one example, the “Code Fragment 3 (Remediation Mask)” 510B includes a link or pointer that can be updated to point to executable code that, as a result of being executed, causes the hosted computing environment to perform the same underlying function as “Code Fragment 3” 504C. Although the parallel code fragments illustrated in FIG. 5 are described in pairs and/or alternatives, the parallel code fragments, in various embodiments, provide additional and/or distinct operations and/or functions. For example, “Code Fragment 4” 504D and “Code Fragment 4 (Remediation Mask)” 510C, as a result of being executed by one or more processors, cause the processors to perform different operations. Continuing this example, “Code Fragment 4 (Remediation Mask)” 510C is used to bypass execution of “Code Fragment 4” 504D.

In various embodiments, during execution of the executable object 522, a selection mask including a set of feature bits is used to select parallel code fragments from the plurality of parallel code fragments. For example, once an initial set of feature bits are selected (e.g., the selection mask associated with the parallel code fragment is provided to the firmware or another component of the hosted computing environment), the executable object 522 is executed, causing selection of particular parallel code fragments for execution. For example, a handshake process 524 is performed between an operating system and firmware of the hosted computing environment to determine an execution path including parallel code fragments of the executable object 522. In one embodiment, parallel code fragments are not enabled, and the code as executed by the host includes a first execution path 526.

At some point prior to, or during, execution of the executable object 522, one or more feature bits are modified by at least obtaining a selection mask 528 (e.g., in response to a user and/or intrusion detection system enabling the parallel code fragments via a user interface). In the example illustrated in FIG. 5, the “Code Fragment 3 (Remediation Mask)” 510B has been enabled by at least providing the corresponding selection mask 528 to the firmware or other component of the hosted computing environment. In various embodiments, the operating system determines that feature bits have changed, and causes the corresponding parallel code fragment to be included or otherwise substituted into a second execution path 530 in place of the code fragment in the first execution path 526 at the time of execution. Although the environment 500 illustrates the executable object 522 as including a particular set of parallel code fragments, other combinations of executable code and parallel code fragments can be used in combination with the various embodiments described. Furthermore, in various embodiments, a plurality of different code paths are generated from the executable object 522, which includes the execution of different parallel code fragments.

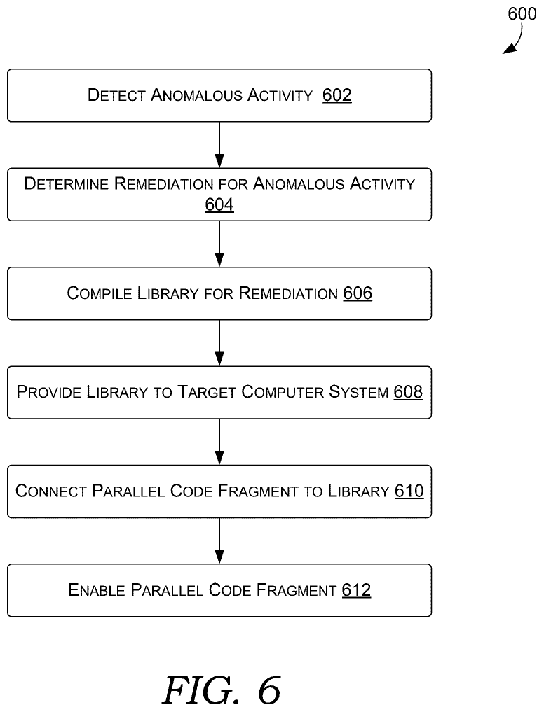

FIG. 6 is a flow diagram showing a method 600 for enabling execution of parallel code fragments to remediate and/or mitigate compromised operations within a hosted computing environment, in accordance with at least one embodiment. The method 600 can be performed, for instance, by the hosted computing environment 120 of FIG. 1. Each block of the methods 600, 700, and 800 and any other methods described herein comprise a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 602, the system implementing the method 600 detects anomalous activity. As described above in connection with FIG. 1, in various embodiments, an intrusion detection system and/or user determines that normal operation of the hosted computing environment is compromised. For example, the user determines that a particular function of an application is vulnerable to malicious activity. At block 604, the system implementing the method 600 determines a remediation for the anomalous activity. For example, the intrusion detection system determines an executable object to use to bypass the compromised operation. In another example, a software developer develops a hotfix, patch, update, or other mechanism for remediating the compromised operation.

At block 606, the system implementing the method 600 compiles a library for remediation. In one example, the intrusion detection system causes a remediation library to be compiled that provides the same functionality as the compromised operation (e.g., the operation associated with the detected anomalous activity). At block 608, the system implementing the method 600 provides the library to the target computer system. For example, the library is provided to a set of hosted computing environments for which the anomalous activity was detected.

At block 610, the system implementing the method 600 connects a parallel code fragment to the library. For example, a pointer (e.g., a thunk or trampoline) is updated to point to a memory location associated with the library. Continuing this example, as described above in connection with FIG. 5, the pointer within the parallel code fragment causes the hosted computing environment executing the executable instruction to continue to a different code path, thereby bypassing the compromised operation encoded in the other code path. At block 612, the system implementing the method 600 enables the parallel code fragment. For example, the selection mask associated with the parallel code fragment is provided to an operating system and/or firmware executed by the hosted computing environment.

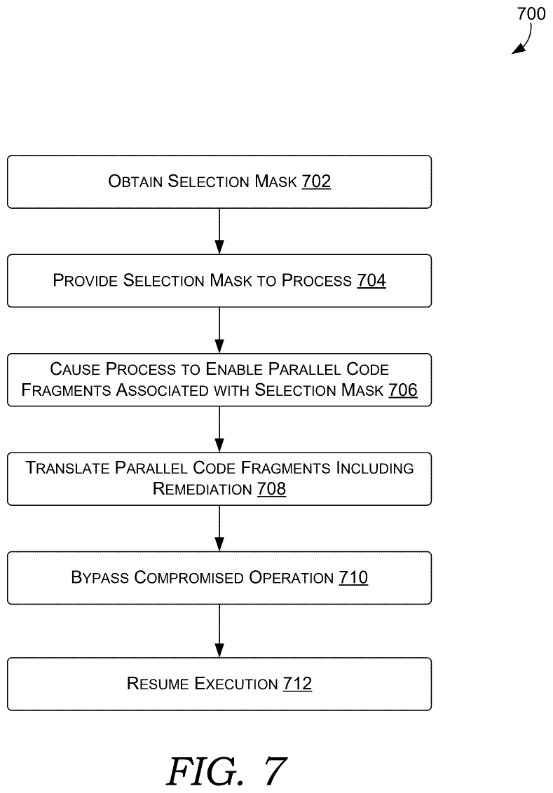

FIG. 7 is a flow diagram showing a method 700 for enabling a parallel code fragment to bypass compromised operations of a hosted computing environment in accordance with at least one embodiment. The method 700 can be performed, for instance, by the hosted computing environment 120 and/or intrusion detection system 116 of FIG. 1. At block 702, the system implementing the method 700 obtains a selection mask including a set of feature bits that indicate to the hosted computing environment executing an executable object that parallel code fragments encoded are enabled during execution of the executable object. In one example, a user determines and/or indicates, through a user interface, parallel code fragments to enable, and an operating system provides the corresponding selection masks to firmware managing execution of the executable object.

At block 704, the system implementing the method 700 provides the selection mask to a process. For example, the operating system causes the executable object to be executed within a process of the operating system. Continuing this example, at block 704, within the system implementing the method 700, providing the selection mask to the process causes the process to selectively enable parallel code fragments with the corresponding selection mask (e.g., set of feature bits). For example, as described above in connection with FIG. 2, the executable object includes the selection mask and metadata that when matched cause execution of the executable object to proceed to the parallel code fragment. At block 706, the system implementing the method 700 causes the process associated with the executable object to enable the parallel code fragment(s) associated with the selection mask. As described above, the operating system, for example, uses a process to control execution of the executable object.

At block 708, the system implementing the method 700 translates the parallel code fragments including the remediation. For example, the firmware translates instructions stored in the hosted computing environment (e.g., the executable object) for execution by at least updating a pointer included in the parallel code fragment to point to executable code that bypassed compromised operation. In another example, the pointer indicates a particular memory location, and the executable instructions are loaded into the particular memory location.

At block 710, the system implementing the method 700 bypasses the compromised operation. For example, as described above, the parallel code fragment causes the hosted computing environment to execute a separate code path that does not include the compromised operation. At block 712, the system implementing the method 700 resumes execution of the executable object. For example, a merge point in the executable code is used to resume execution of the code in the executable object.

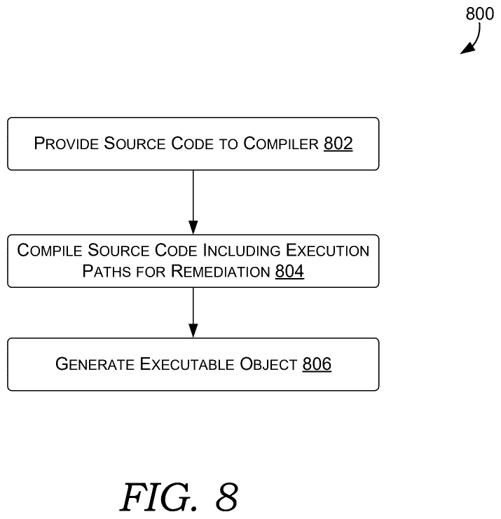

FIG. 8 is a flow diagram showing a method 800 for generating an executable object including parallel code fragments for remediation in accordance with at least one embodiment. At block 802, the system implementing the method 800 provides source code to a compiler. For example, a developer can generate source code that encodes instructions in a programming language. At block 804, the system implementing the method 800 compiles the source code including execution paths for remediation. For example, the source code includes or the compiler otherwise determines locations to include parallel code fragments that, as a result of being enabled, bypass operations of the executable object. Continuing this example, the compiler generates machine code that can be included in an executable object to enable execution of the operations by a processor, including selection masks for enabling the parallel code fragments and execution paths including one or more parallel code fragments. At block 806, the system implementing the method 800 generates an executable object. In one example, the compiler encodes the instructions in a format that is executable by the hosted computing environment.

Having described embodiments of the present disclosure, FIG. 9 provides an example of a computing device in which embodiments of the present disclosure may be employed. Computing device 900 includes bus 910 that directly or indirectly couples the following devices: memory 912, one or more processors 914, one or more presentation components 916, input/output (I/O) ports 918, input/output components 920, and power supply 922. Bus 910 represents what may be one or more buses (such as an address bus, data bus, or combination thereof). Although the various blocks of FIG. 9 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. The inventors recognize that such is the nature of the art and reiterate that the diagram of FIG. 9 is merely illustrative of an exemplary computing device that can be used in connection with one or more embodiments of the present technology. Distinction is not made between such categories as “workstation,” “server,” “laptop,” “handheld device,” etc., as all are contemplated within the scope of FIG. 9 and reference to “computing device.”Computing device 900 typically includes a variety of computer-readable media. Computer-readable media can be any available media that can be accessed by computing device 900 and includes both volatile and non-volatile media, removable and non-removable media. By way of example, and not limitation, computer-readable media may comprise computer storage media and communication media. Computer storage media includes both volatile and non-volatile, removable and non-removable media implemented in any method or technology for storage of information such as computer-readable instructions, data structures, program modules, or other data. Computer storage media includes, but is not limited to, Random Access Memory (RAM), Read-only Memory (ROM), Electrically Erasable Programmable Read-Only Memory (EEPROM), flash memory or other memory technology, Compact Disc (CD)-ROM, digital versatile disks (DVDs) or other optical disk storage, magnetic cassettes, magnetic tape, magnetic disk storage or other magnetic storage devices, or any other medium that can be used to store the desired information and which can be accessed by computing device 900. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, Radio Frequency (RF), infrared, and other wireless media. Combinations of any of the above should also be included within the scope of computer-readable media.

Memory 912 includes computer storage media in the form of volatile and/or nonvolatile memory. As depicted, memory 912 includes instructions 924. Instructions 924, when executed by processor(s) 914, are configured to cause the computing device to perform any of the operations described herein, in reference to the above discussed figures, or to implement any program modules described herein. The memory may be removable, non-removable, or a combination thereof. Exemplary hardware devices include solid-state memory, hard drives, optical-disc drives, etc. Computing device 900 includes one or more processors that read data from various entities such as memory 912 or I/O components 920. Presentation component(s) 916 present data indications to a user or other device. Exemplary presentation components include a display device, speaker, printing component, vibrating component, etc.

I/O ports 918 allow computing device 900 to be logically coupled to other devices including I/O components 920, some of which may be built-in. Illustrative components include a microphone, joystick, game pad, satellite dish, scanner, printer, wireless device, etc. I/O components 920 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on computing device 900. Computing device 900 may be equipped with depth cameras, such as stereoscopic camera systems, infrared camera systems, Red Green Blue (RGB) camera systems, and combinations of these, for gesture detection and recognition. Additionally, computing device 900 may be equipped with accelerometers or gyroscopes that enable detection of motion. The output of the accelerometers or gyroscopes may be provided to the display of computing device 900 to render immersive augmented reality or virtual reality.

Embodiments presented herein have been described in relation to particular embodiments that are intended in all respects to be illustrative rather than restrictive. Alternative embodiments will become apparent to those of ordinary skill in the art to which the present disclosure pertains without departing from its scope.

Various aspects of the illustrative embodiments have been described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features have been omitted or simplified in order to not obscure the illustrative embodiments.

Various operations have been described as multiple discrete operations, in turn, in a manner that is most helpful in understanding the illustrative embodiments; however, the order of description should not be construed as to imply that these operations are necessarily order dependent. In particular, these operations need not be performed in the order of presentation. Further, descriptions of operations as separate operations should not be construed as requiring that the operations be necessarily performed independently and/or by separate entities. Descriptions of entities and/or modules as separate modules should likewise not be construed as requiring that the modules be separate and/or perform separate operations. In various embodiments, illustrated and/or described operations, entities, data, and/or modules may be merged, broken into further sub-parts, and/or omitted.

The phrase “in one embodiment” or “in an embodiment” is used repeatedly. The phrase generally does not refer to the same embodiment; however, it may. The terms “comprising,” “having,” and “including” are synonymous, unless the context dictates otherwise. The phrase “A/B” means “A or B.” The phrase “A and/or B” means “(A), (B), or (A and B).” The phrase “at least one of A, B, and C” means “(A), (B), (C); (A and B); (A and C); (B and C); or (A, B, and C).”

What is claimed is:

1. A method comprising:
determining a first segment of executable code of an executable object is compromised, the executable object including a parallel code fragment;
in response to determining the first segment of executable code of the executable object is compromised, obtaining a selection mask including metadata for identifying the parallel code fragment; and
in response to detecting the selection mask in the executable object, enabling execution of the parallel code fragment to bypass the first segment of executable code of the executable object by at least:
causing a second segment of executable code to be obtained;
updating a pointer included in the parallel code fragment to point to the second segment of executable code; and
causing the second segment of executable code to be executed as a result of executing the parallel code fragment.

2. The method of claim 1, wherein executing the parallel code fragment causes a second code path including the second segment of executable code to be executed that bypasses a first code path including the first segment of executable code.

3. The method of claim 1, wherein the second segment of executable code includes a library that performs a function of the first segment of executable code.

4. The method of claim 3, wherein updating the pointer further comprises causing the pointer to point to the library.

5. The method of claim 1, wherein the executable object includes a plurality of parallel code fragments and a plurality of code segments encoded in the executable object to enable code segments of the plurality of code segments to be bypassed, where the first segment is a member of the plurality of code segments.

6. The method of claim 1, wherein determining the first segment of executable code of the executable object is compromised further comprises obtaining an indication from an intrusion detection system.

7. The method of claim 1, wherein the executable object includes a plurality of parallel code fragments that are enabled by the selection mask and cause the first segment of executable code to be bypassed during execution of the executable object.

8. One or more computer storage media having executable instructions embodied thereon, that, as a result of being executed by a processing device, cause the processing device to perform operations comprising:
executing an application based on an executable object including a plurality of code segments and a parallel code fragment containing an operation that, as a result of being executed by the processing device, causes the processing device to bypasses a first code segment of the plurality of code segments;
in response determining a vulnerability in the first code segment, enabling the parallel code fragment based on a selection mask;
obtaining a second code segment to perform a function of the first code segment;
updating a pointer associated with the parallel code fragment to correspond to the second code segment; and
bypassing the first code segment by at least executing the parallel code fragment.

9. The media of claim 8, wherein the processing device further performs the operations comprising resuming execution of the application at a merge point encoded in the executable object as a result of the second code segment performing the function of the first code segment.

10. The media of claim 8, wherein the vulnerability in the first code segment is determined by an intrusion detection system of a hosted computing environment executing the application.

11. The media of claim 8, wherein obtaining the second code segment further comprises compiling the second code segment to generate a second executable object.

12. The media of claim 11, wherein the second executable object is a library.

13. The media of claim 8, wherein the processing device further performs the operations comprising obtaining a second executable object that, as a result of being executed, modifies the first code segment to remediate the vulnerability.

14. The media of claim 8, wherein the pointer includes a thunk.

15. The media of claim 8, wherein executing the parallel code fragment further comprises executing a code path associated with a memory location indicated in the pointer including the second code segment.

16. A system comprising:
a processor; and
a memory coupled to the processor storing instructions that, as a result of being executed by the processor, cause the processor to:
execute a set of operations encoded in a first executable object including a parallel code fragment, where the parallel code fragment includes a pointer to a first memory location;
generate a determination that a first operation of the set of operations is compromised;
in response to the determination, enable the parallel code fragment within the first executable object;
obtain a second operation encoded in a second executable object, where the first operation and the second operation, as a result of being executed, causes the processor to perform a function;
update the pointer to indicate a second memory location associated with the second executable object; and
bypass the first operation by at least executing the parallel code fragment and causing the processor to execute the second operation based on the pointer indicating the second memory location.

17. The system of claim 16, wherein the memory further includes instructions that, as a result of being executed by the processor, cause the processor to:
obtain a third executable object that, as a result of being executed by the processor, causes the processor to remediate the first operation; and
disable the parallel code fragment within the first executable object.

18. The system of claim 16, wherein enabling the parallel code fragment within the first executable object further comprises provide a selection mask associated with the parallel code fragment to an operating system managing execution of the first executable object.

19. The system of claim 18, wherein the selection mask is provided in response to a user enabling the parallel code fragment in a user interface.

20. The system of claim 18, wherein, prior to obtaining the selection mask, the processor executes the first operation encoded in the first executable object without executing the parallel code fragment.
